(19) United States
(12) Patent Application Publication
(10) Pub. No.: US 2020/0273271 A1
(43) Pub. Date: Aug. 27, 2020

(54) ELECTRONIC PADLOCK

(71) Applicants: FANG-YI FAN, CHIAYI CITY (TW); CHUAN-TIEN FAN, TAIPEI CITY (TW); YU-CHUN KAO, CHIAYI COUNTY (TW)

(72) Inventors: FANG-YI FAN, CHIAYI CITY (TW); CHUAN-TIEN FAN, TAIPEI CITY (TW); YU-CHUN KAO, CHIAYI COUNTY (TW)

(21) Appl. No.: 16/285,504

(22) Filed: Feb. 26, 2019

(51) Int. Cl. G07C 9/00; E05B 67/22

(52) U.S. Cl. CPC G07C 9/00896; E05B 67/22; G07C 2009/00642; G07C 2009/00539; G07C 2009/00761

(57) ABSTRACT

The present invention discloses an electronic padlock which comprises a housing, an U-shaped shackle having a first lock shaft and a second lock shaft, a power source and a lock assembly. The power source is disposed in the housing and has a switch block at an output terminal. The lock assembly is disposed above the power source in the housing and has two corresponding lock units and a second elastic member between the two lock units. Each of the two lock units has a lock tongue at an external side corresponding to two lock recesses in the first lock shaft and the second shaft of the U-shaped shackle respectively, a top pushing cave having a guiding chamfer corresponding to the switch block of the power source.

### BACKGROUND OF THE INVENTION

### 1. Field of the Invention

The present invention relates to an electronic padlock which does not disintegrate when being used and has a simple structure and a longer service life; a U-shaped shackle of the present invention is popped out automatically by a top bracing force of an elastic member in the present invention during an unlocking process, so the present invention is convenient in use, avoids accidental wrong actions and has anti-theft effect so as to increase practicality in its overall application.

### 2. Description of Related Art

Nowadays, a padlock can be controlled by a wireless signal. For instance, a padlock controlled by a wireless signal of the Taiwan Pat. No. TWI593867 (B) issued on 1 Aug. 2017, comprises a housing, a lock assembly, a power component, a lock core assembly, a circuit component and a battery assembly. The housing has a seat and a cover removably assembled to one side of the seat, a fixing member connected to the cover by one end, and a shackle movably and rotatory inserted into the seat for buckling and fixing the fixing member to the shackle. The lock assembly is disposed in the housing to buckle and fix to the shackle. The power component is disposed in the housing and connected to the lock assembly, and drives the lock assembly to fasten to the shackle. The lock core assembly is disposed in the housing and has a lock core, a driving member and a first elastic member. The lock core has one end protruding from the housing. The driving member is movably connected to the lock core and buckled to the lock assembly, and driven to rotate by the lock core. The first elastic member is connected to the driving member for moving the driving member away from the lock assembly. When a corresponding key is inserted into the lock core to a fixed position, the key pushes the driving member for buckling to the lock assembly. The circuit component is disposed in the housing, electrically connected to the power component and receiving a wireless signal. The battery assembly is disposed in the housing and electrically connected to the power component and the circuit component.

Although the padlock described above is controlled by a wireless signal to lock or unlock the padlock as expected, it still needs to be improved. A gear on a motor of the power component is engaged to a sawtooth of the lock assembly to drive the lock assembly to rotate, but the gear of the motor and the sawtooth of the lock assembly are easily disintegrated after long-term use and the padlock cannot be used anymore so as to affect its service life. Therefore, the whole structure of the padlock needs to be improved.

### SUMMARY OF THE INVENTION

The present invention relates to an electronic padlock which does not disintegrate when being used and has a simple structure and a longer service life. A U-shaped shackle of the present invention is popped out automatically by a top bracing force of an elastic member in the present invention during an unlocking process, so the present invention is convenient in use, avoids accidental wrong actions and has anti-theft effect so as to increase practicality in its overall application.

### BRIEF DESCRIPTION OF THE DRAWINGS

FIG. 1 is an exploded diagram showing an electronic padlock of the present invention;

FIG. 2 is a stereogram showing an electronic padlock of the present invention;

FIG. 3 is a cross-sectional diagram showing a side view of the present invention in a locked state;

FIG. 4 is a cross-sectional diagram showing a bottom view of the present invention;

FIG. 5 is a cross-sectional diagram showing a side view of the present invention in an unlocked state;

FIG. 6 is a cross-sectional diagram showing a bottom view of the present invention in an unlocked state.

### DETAILED DESCRIPTION OF THE PREFERRED EMBODIMENT

To provide a thorough understanding, the purpose and advantages of the present invention will be described in detail with reference to the accompanying drawings.

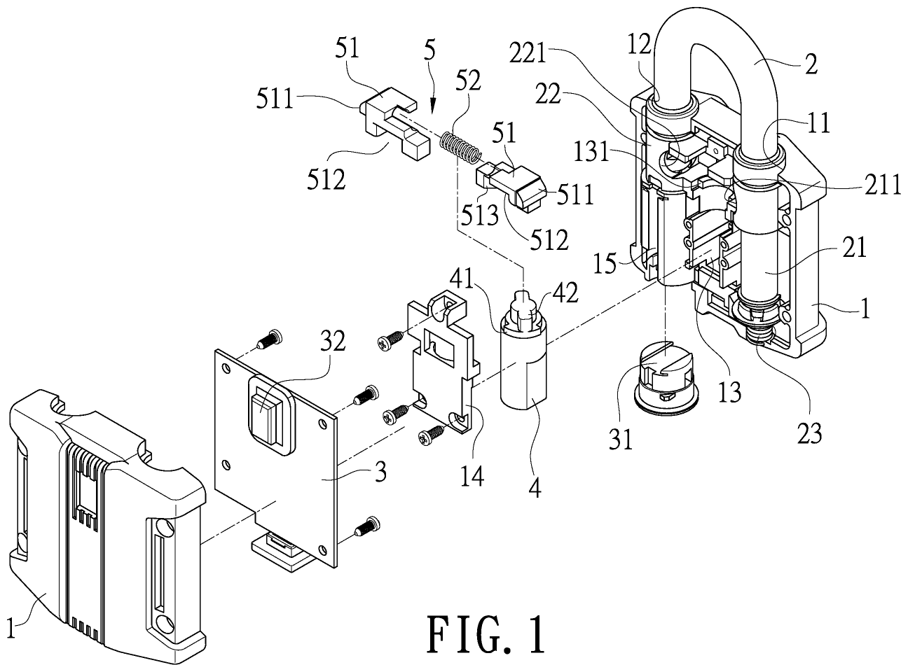

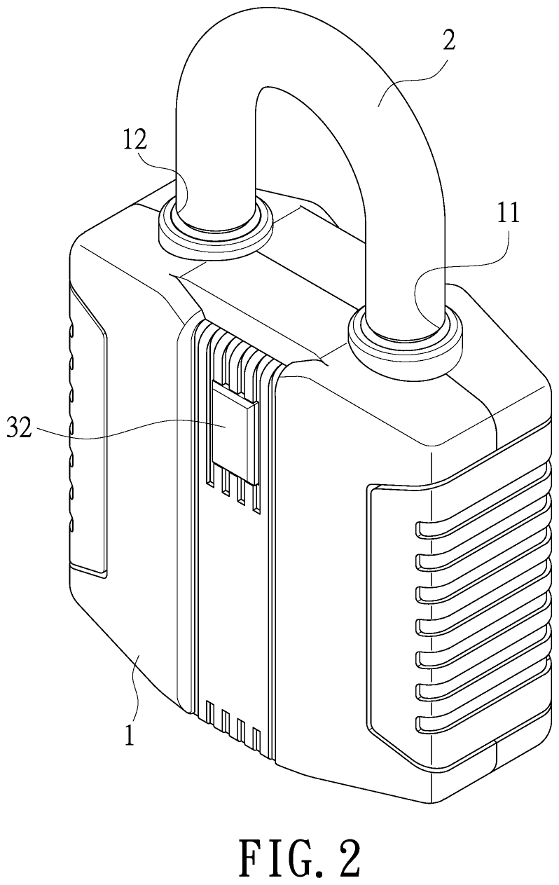

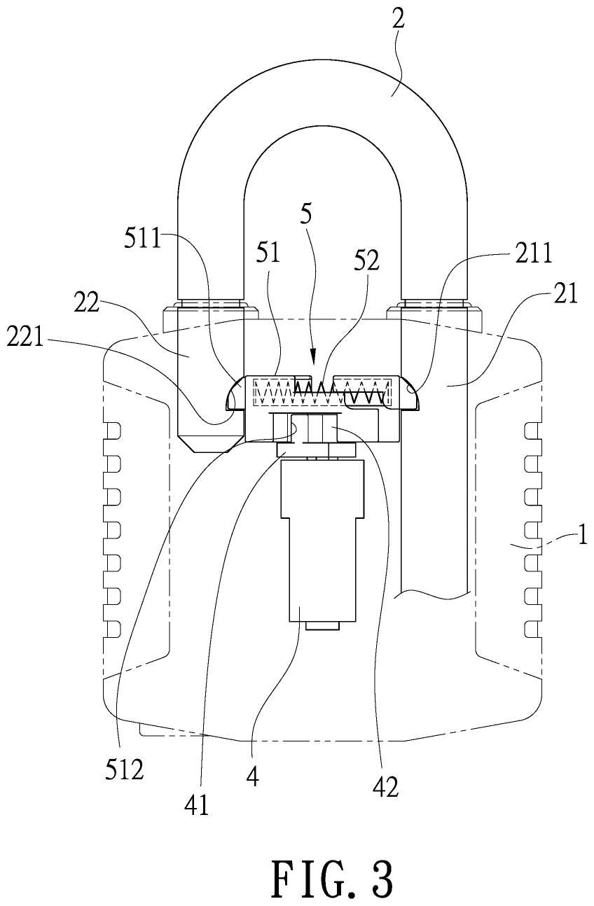

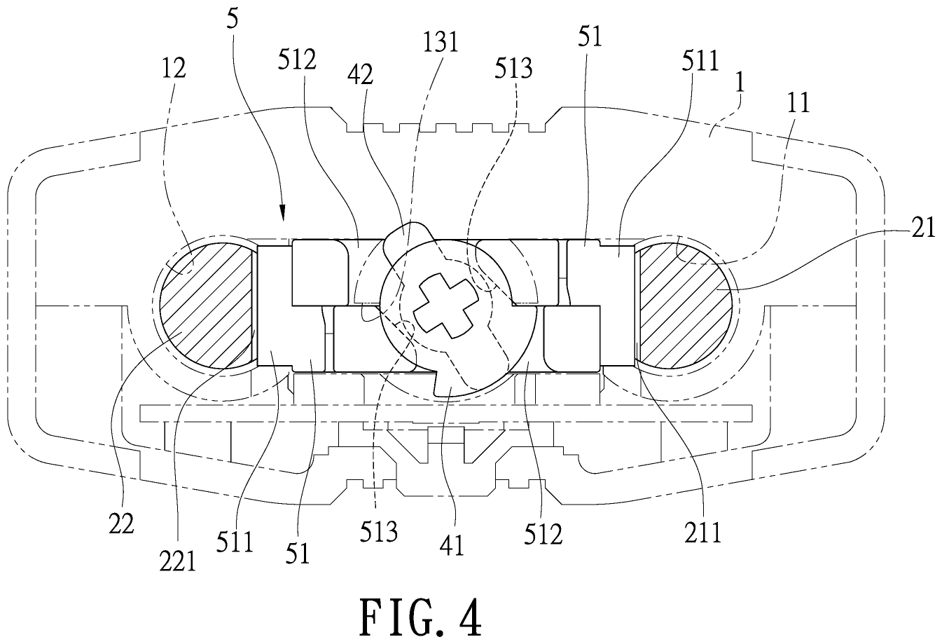

Referring to FIG. 1, FIG. 2, FIG. 3 and FIG. 4, an exploded diagram, a stereogram and two cross-sectional diagrams respectively showing a side view and a bottom view of the present invention are disclosed. The electronic padlock of the present invention comprises a housing (1), an U-shaped shackle (2), a control unit (3), a power source (4) and a lock assembly (5).

The housing (1) has a pivot hole (11) and a lock hole (12) bored at an upper side, a chamber (13) formed in the housing (1) between the pivot hole (11) and the lock hole (12), a fixing cover (14) disposed outside of the chamber (13) for covering, and a battery holder (15) disposed in the housing (1). The chamber (13) has a positioning ring portion (131) therein.

The U-shaped shackle (2) has a first lock shaft (21), a second lock shaft (22) and a first elastic member (23). The first lock shaft (21) is rotatory inserted in the pivot hole (11) of the housing (1). The second lock shaft (22) is pressably inserted into the lock hole (12) of the housing (1). The first lock shaft (21) is provided with a first lock recess (211) recessed therein, and the second lock shaft (22) is provided with a second lock recess (221) recessed therein corresponding to the first lock recess (211). The first elastic member (23) is disposed in the housing (1) to connect an end terminal of the first lock shaft (21) to the housing (1) and support the first lock shaft (21).

The control unit (3) is disposed in the housing (1) and receives a wireless control signal transmitted from an intelligent terminal device. In one embodiment, the wireless control signal is a Bluetooth signal. The control unit (3) is further electrically connected to a battery (31) disposed in the battery holder (15) of the housing (1) which supplies electricity to the control unit (3). The control unit (3) is further provided with a control button (32) protruding from the housing (1). The control unit (3) can receive the wireless control signal transmitted from the intelligent terminal device only when the control button (32) is pressed by a user.

The power source (4) is disposed in the chamber (13) of the housing (1) and electrically connected to the control unit (3). The power source (4) comprises a positioning projection (41) and a switch block (42). The positioning projection (41) is disposed at an output terminal of the power source (4) corresponding to the positioning ring portion (131) of the chamber (13), and the switch block (42) is disposed outside the positioning projection (41).

The lock assembly (5) is disposed above the power source (4) in the chamber (13) of the housing (1). The lock assembly (5) has two corresponding lock units (51) and a second elastic member (52) disposed between the two lock units (51). Each of the two lock units (51) has a lock tongue (511) protruded at an external side thereof corresponding to the first lock recesses (211) in the first lock shaft (21) and the second lock recesses (221) in the second lock shaft (22) respectively. Each of the two lock units (51) is further provided with a top pushing cave (512) corresponding to the switch block (42) of the power source (4) and a guiding chamfer (513) in the top pushing cave (512).

To lock the present invention, the second lock shaft (22) of the U-shaped shackle (2) is pressed into the lock hole (12) of the housing (1) and the first lock shaft (21) is driven to push the first elastic member (23) at the same time. The two lock units (51) of the lock assembly (5) are moved outward by a rebound force of the second elastic member (52) to respectively engage the lock tongue (511) of each of the lock units (51) with the first lock recess (211) of the first shaft (21) and the second lock recess (221) of the second shaft (22). Therefore, the electronic padlock of the present invention is locked.

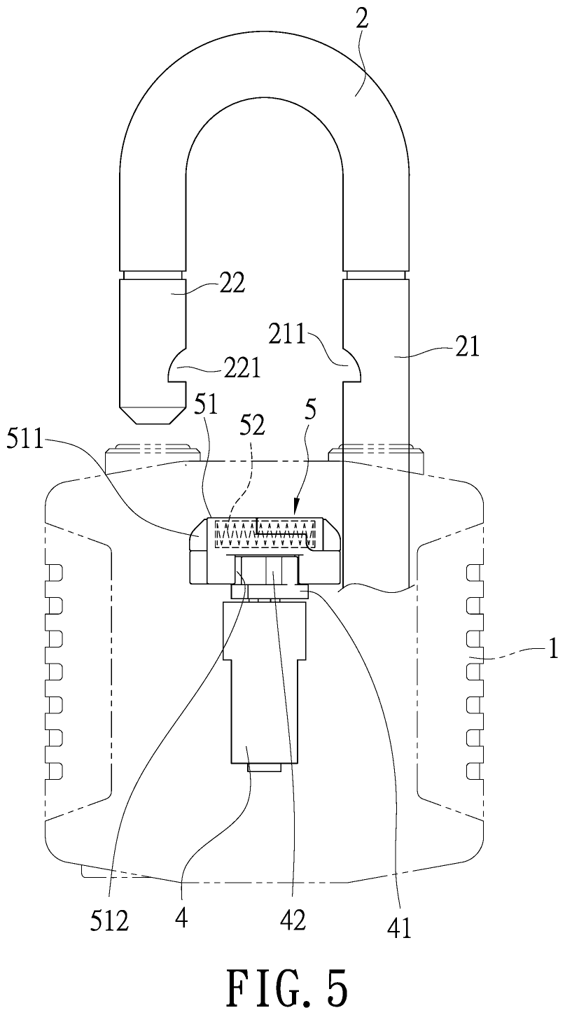

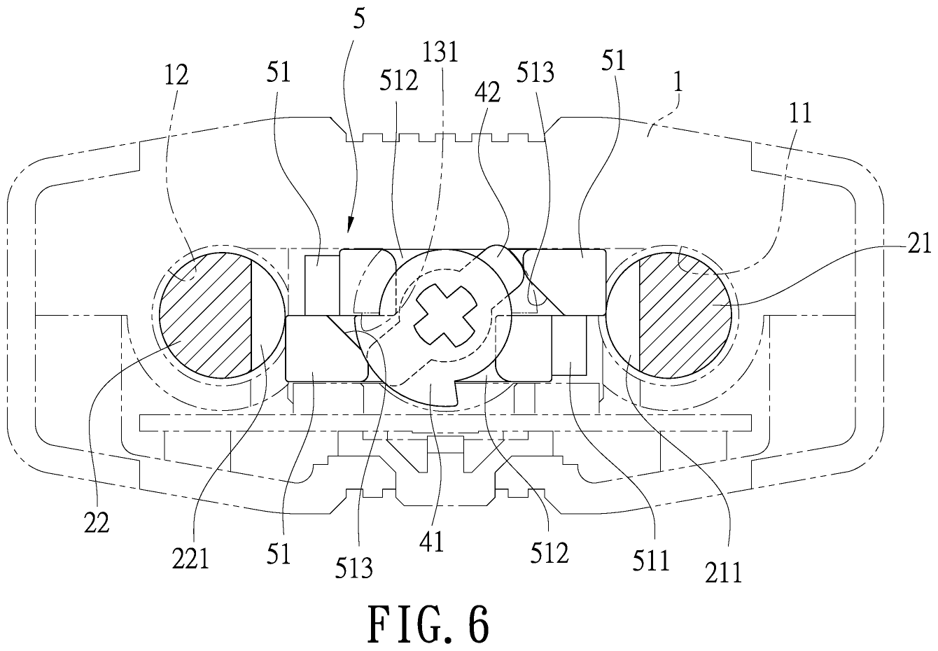

Referring to FIG. 5 and FIG. 6, to unlock the present invention, a user pressed the control button (32) of the control unit (3) for controlling the control unit (3) to receive a wireless control signal transmitted from the intelligent terminal device. After receiving the wireless control signal, the control unit (3) drives the power source (4) to rotate the output terminal thereof. The switch block (42) of the power source (4) is then moved alone the guiding chamfer (513) in the top pushing cave (512) of the lock unit (51) of the lock assembly (5) and pushes the two lock units (51) inward, then the second elastic member (52) is compressed by the two lock unit (51). When the positioning projection (41) of the power source (4) is blocked by the positioning ring portion (131), the lock tongue (511) of each of the two lock units (51) is detached from the first lock recess (211) of the first lock shaft (21) and the second lock recess (221) of the second lock shaft (22) to unlock the U-shaped shackle (2), so the first loch shaft (21) is in a unlocked state. In the meantime, the first elastic member (23) disposed between the first lock shaft (21) and the housing (1) is rebounded to push the first lock shaft (21) outwardly so as to make the second lock shaft (22) pop out from the lock hole (12) of the housing (1) to unlock the present invention.

According to the structure and the embodiment described above, the present invention has the following advantages compared to the existing structure:

1. In the present invention, each of the top pushing cave of the two lock units is pushed and moved directly by the switch block at the output terminal of the power source for detaching the U-shaped shackle from the two lock units, so the present invention avoids a disintegrated situation and has a simpler structure and a longer service life.

2. In the present invention, a first elastic member is disposed between the first lock shaft of the U-shaped shackle and the housing to push the first lock shaft outwardly by a rebounded force thereof when the U-shaped shackle is detached from the lock assembly, and the second lock shaft is then popped out from the lock hole of the housing to unlock the present invention; therefore, the present invention is convenient in use.

3. In the present invention, the control unit comprises a control button protruding from the housing, and the control unit can receive a wireless control signal transmitted from the intelligent terminal device only when the control button is pressed by a user; so the present invention avoids accidental wrong actions and has efficacy of anti-theft so as to increase practicality in its overall application.

What is claimed is:

1. An electronic padlock, comprising:
a housing having a pivot hole and a lock hole bored at an upper side thereof, a chamber formed in the housing between the pivot hole and the lock hole, and a battery holder therein;
an U-shaped shackle having a first lock shaft rotatory inserted into the pivot hole of the housing, a second lock shaft pressably inserted into the lock hole of the housing, and a first elastic member disposed in the housing for connecting an end terminal of the first lock shaft to the housing for supporting, and two lock recesses respectively recessed in the first lock shaft and the second lock shaft correspondingly;
a control unit disposed in the housing for receiving a wireless control signal and connecting a battery disposed in the battery holder of the housing for supplying electricity thereto;
is a power source disposed in the chamber of the housing and electrically connected to the control unit and having a switch block at an output terminal thereof;
a lock assembly disposed in the housing above the power source in the chamber and having two corresponding lock units and each of which has a lock tongue protruded at an external side thereof corresponding to the lock recesses in the first lock shaft and the second shaft of the U-shaped shackle respectively, a top pushing cave having a guiding chamfer therein corresponding to the switch block of the power source, and a second elastic member disposed between the two lock units.

2. The electronic padlock as claimed in claim 1, wherein the housing is provided with a positioning ring portion in the chamber, and wherein the power source is provided with a positioning projection at the output terminal thereof corresponding to the positioning ring portion.

3. The electronic padlock as claimed in claim 1, wherein the housing is provided with a fixing cover outside the chamber for covering.

4. The electronic padlock as claimed in claim 1, wherein the wireless control signal received by the control unit is transmitted from an intelligent terminal device.

5. The electronic padlock as claimed in claim 1, wherein the wireless control signal is a Bluetooth signal.

6. The electronic padlock as claimed in claim 4, wherein the wireless control signal is a Bluetooth signal.

7. The electronic padlock as claimed in claim 4, wherein the control unit comprises a control button protruding from the housing for controlling the control unit to receive the wireless control signal transmitted from the intelligent terminal device as the control button is pressed.
